(19) United States
(12) Patent Application Publication
(10) Pub. No.: US 2019/0124944 A1
(43) Pub. Date: May 2, 2019

(54) MACHINE FOR CRUSHED-ICE DRINKS, BEVERAGES OR SIMILAR

(71) Applicant: FA.LU. S.R.L., Napoli (IT)

(72) Inventor: Maurizio CAIANO, Napoli (IT)

(73) Assignee: FA.LU. S.r.l., Napoli (IT)

(21) Appl. No.: 16/091,834

(22) PCT Filed: May 9, 2017
(86) PCT No.: PCT/IB2017/052690

§ 371 Date: Oct. 5, 2018

(30) Foreign Application Priority Data
Jun. 23, 2016 (IT) 202016000065238

(51) Int. Cl. A23G 9/04; A23G 9/20; A23G 9/22

(52) U.S. Cl. CPC A23G 9/045; A23G 9/22; A23G 9/20

(57) ABSTRACT

A machine for producing and dispensing bar products, such as frozen crushed-ice drink, hot beverages or the like.

### CROSS-REFERENCE TO RELATED APPLICATIONS

This application is a 35 U.S.C. § 371 National Phase of PCT Application No. PCT/IB2017/052690 filed May 9, 2017, which claims priority to Italian Application No. IT 202016000065238 filed Jun. 23, 2016. The disclosures of these prior applications are hereby incorporated by reference herein.

### BACKGROUND

The present invention relates to a machine improved for producing and dispensing bar products, such as frozen crushed-ice drinks, or similar.

Traditionally, many problems are faced by this type of machines, all linked to the need for constructing machines according to compromises between performances, sizes, reliability, capability, aesthetics, etc.

All this leads to the implementation of machines which, for example, suffer from problems in keeping the product at the right temperature inside the mixing and containing tanks. In fact, for example if one wants to make such tanks of transparent materials to allow the consumer users to see the product, it is not possible to apply insulating materials outside the tank itself.

Furthermore, still by way of example, the complex shape of the tank and the presence of a vertical dispensing group (of the type commonly adopted on this type of machines) makes particularly complex the implementation of lagging insulating coatings which should be effective in each point wherein the product could stand.

Another problem faced by the currently known machines is more linked to the hygiene aspect and the product preservation.

In particular, in all currently available machines, there is at least one portion of the tank and/or of the dispensing group, wherein there is always residual product after one dispensing procedure. This involves that upon the subsequent dispensing procedure, the residual product is dispensed together with the fresh one.

However, often these machine portions wherein the product stagnates are neither refrigerated nor insulated, as in case of machines with vertical dispensing group. It follows that upon each dispensing procedure one even risks to dispense a quantity of not perfectly preserved product.

Still an additional need can be found in the machines intended to dispense beverages or carbonated crushed-ice drinks.

In fact, it is well known that a carbonated beverage, not preserved in absolutely airtight containers, tends to loose slowly its gas content, thus deteriorating flavour and taste.

On the other side, in these machines it is unavoidable that the product preserved therein, at least in some moments (for example the dispensing moment) is in contact with air and that, consequently, over time the gas concentration inside thereof tends to decrease.

### SUMMARY

The present disclosure relates to a machine which could keep unaltered over time the gas concentration in the product inside the machine, so as to be able to offer a product to the best of its properties.

The aspect of the present invention may include a machine for frozen crushed-ice drinks or the like as defined in claim 1.

Secondary features of the machine according to the present invention are further defined in the depending claims.

### BRIEF DESCRIPTION OF THE DRAWINGS

The advantages, as well as the features and the use modes of the present invention will result evident from the following detailed description of a preferred embodiment thereof, shown by way of example and not for limitative purpose, by making reference to the figures of the enclosed drawings, wherein:

FIG. 1 is an overall view of a machine according to the present invention;

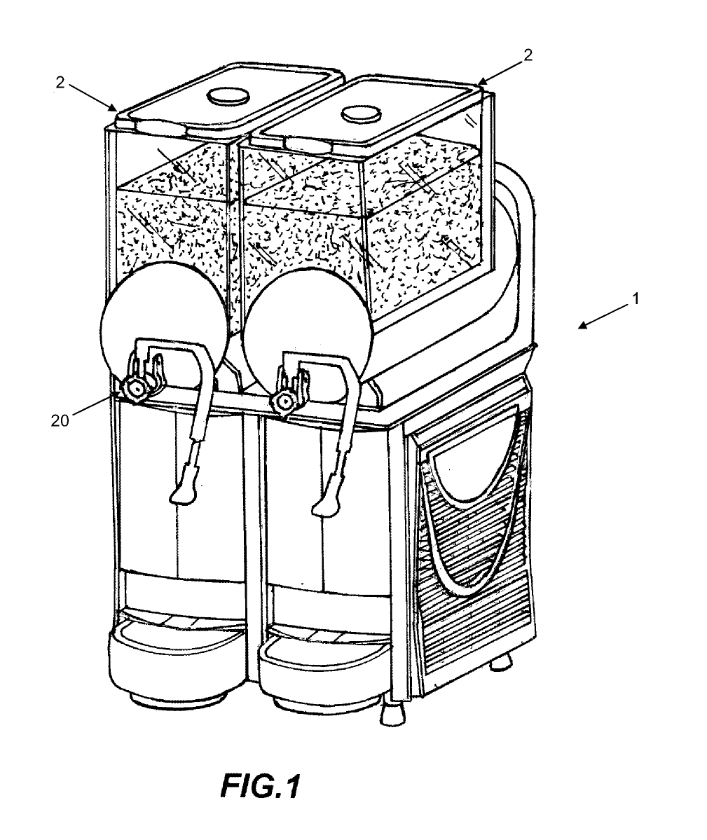

FIG. 2 is an exploded view of a mixing tank and of an outer coating of the same, showing a possible coupling mode thereof;

FIG. 3 is a view showing in particular the coating structure;

FIG. 4 is a view of a tank with the coupled outer coating;

FIG. 5 is an exploded view of a dispensing group with horizontal axis according to the present invention;

FIGS. 6A and 6B are views showing the dispensing group in the two closed and open configurations, respectively;

FIG. 7 is a view of a machine according to an additional possible embodiment; and

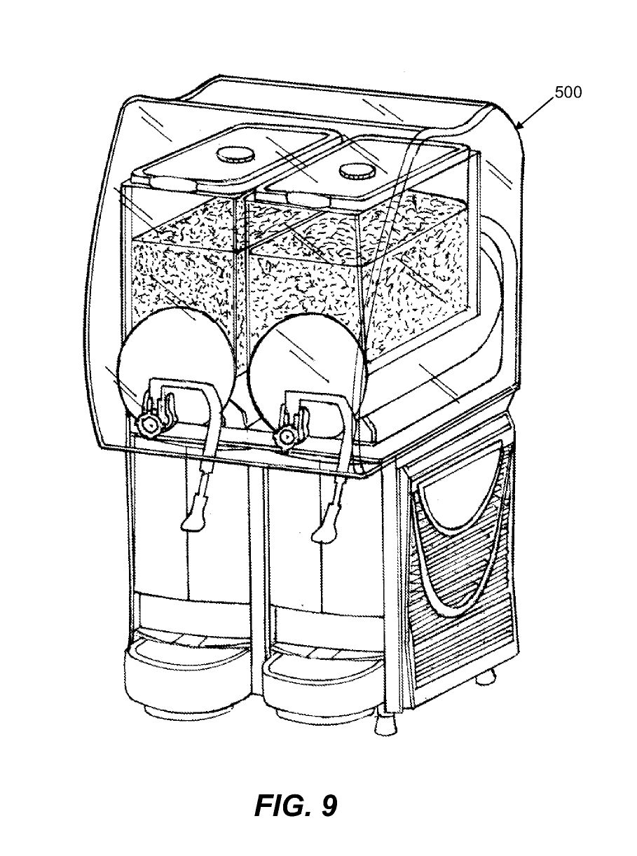

FIGS. 8 to 10 are views of a machine still according to an additional alternative embodiment.

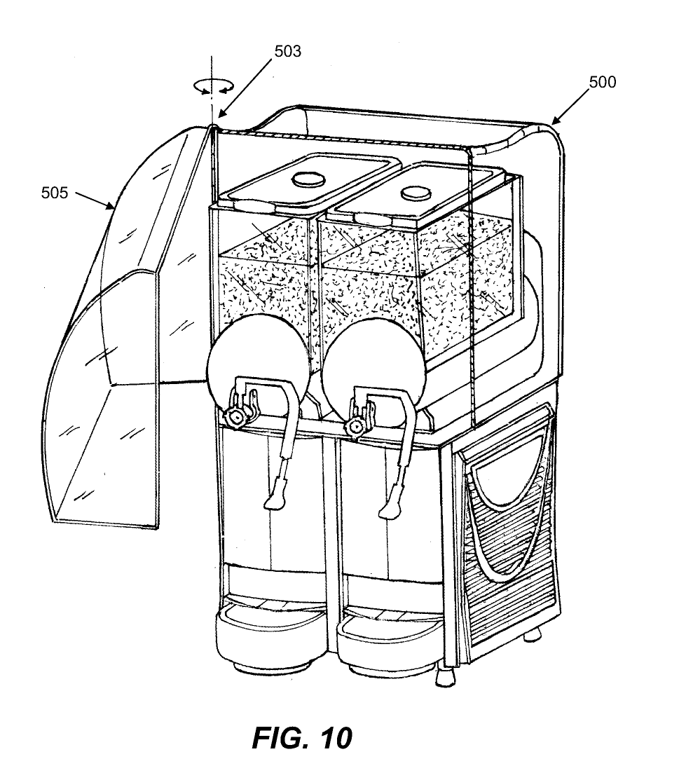

In order to describe the present invention the figures mentioned above will be referred to.

### DETAILED DESCRIPTION

In general terms, the present invention relates to a countertop machine 1.

Such machine, generally known for producing and dispensing products in form of beverages and/or crushed-ice drinks, first of all comprises a tank 2 for mixing the product. The tank 2 typically is shaped to house a mixing group, not visible in figures.

According to the present invention, the machine is arranged for housing a mixing group with horizontal development and, to this purpose, it has a front wall 5 and a corresponding rear wall 6, side walls 7 and a bottom 8.

It is to be meant that the machine will be equipped with a supporting frame and a group for cooling/heating the product contained in the tank 2, and with corresponding means for inverting the refrigerating cycle of such group. Thanks to such additional functionality, the machine can immediately be adapted for preparing hot instead of frozen products, depending upon the needs and/or the season. This, of course, without altering in any way the inventive principle and the mixing and dispensing functionalities of the machine.

Such peculiarities are to be meant within the comprehension of a person skilled in the art and thus they will be not described herein in details.

Moreover, although the figures show a machine of ‘double’ type, that is having two tanks for the products to be dispensed, it is to be meant that such configuration has not to be considered limitative to the purpose of the present description.

According to the present invention, on the front wall 5 of the tank 2, and more exactly proximate to the bottom 8, an engagement hole 10 is implemented for a dispensing group 20 of the type with horizontal development.

The engagement of the dispensing group 20 in the engagement hole 10 could be implemented according to different modes which the manufacturer could suitably select among the available ones. Preferably, the engagement type is of reversible type, to allow a complete disassembly of the dispensing group, for maintenance.

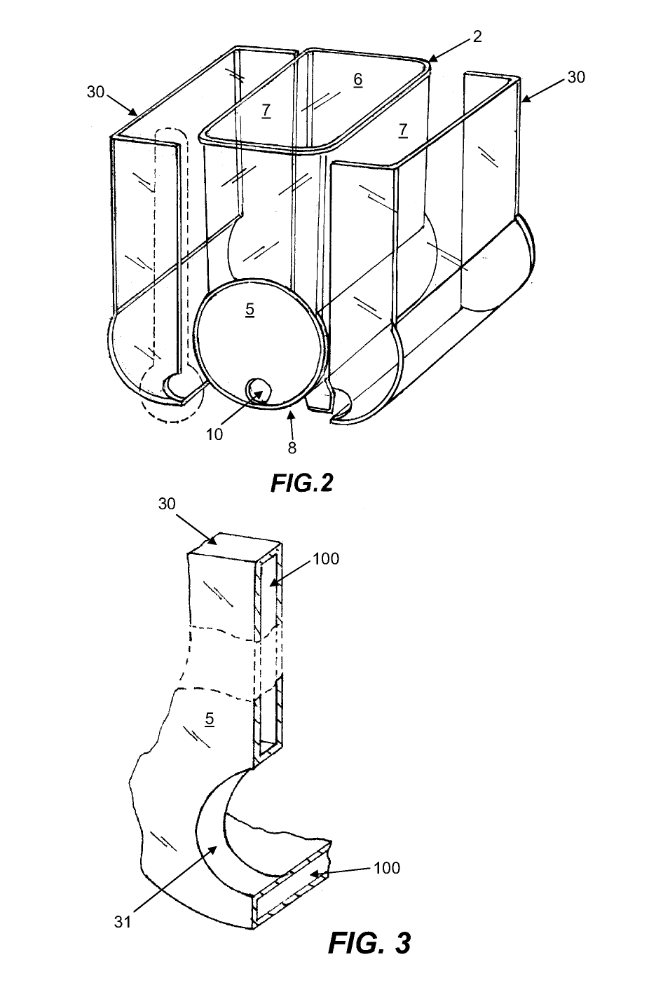

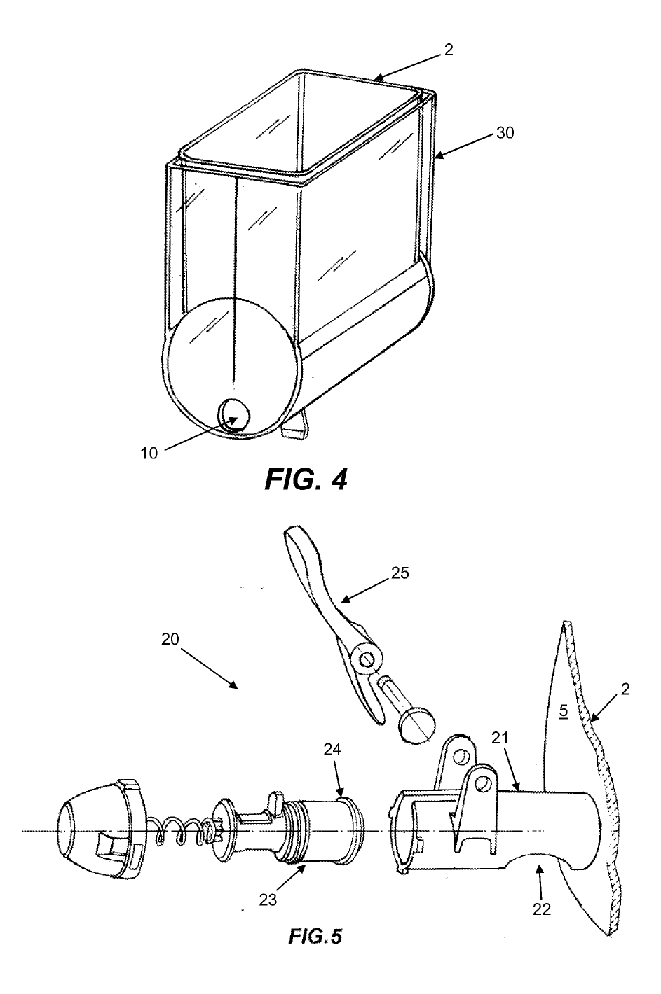

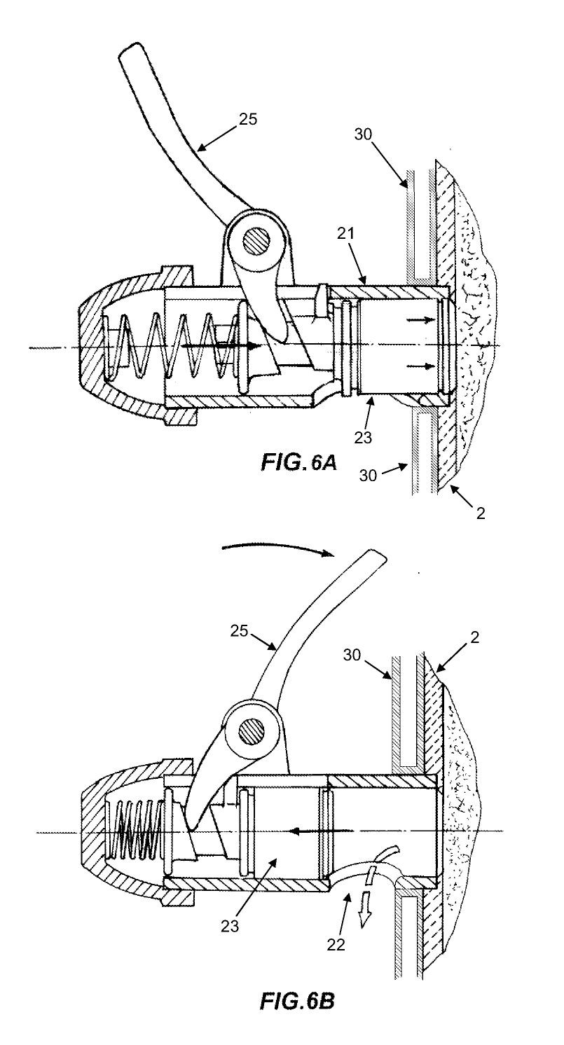

By referring in particular to FIGS. 2 to 4, a mixing tank 2 of the machine, together with an outer coating thereof 30, is shown more in detail.

As clearly illustrated, the coating 30 is implemented so as to form a hollow and sealed lagging element, defining a continuous air gap 100 along the front 5, rear 6, side walls 7 and said bottom 8 of the mixing tank 2.

As illustrated in FIG. 2, the coating 30 advantageously can be formed by at least two portions coupled and sealed therebetween during the assembly phase of the machine.

The air gap 100 formed by the coating 30, advantageously can be filled-in with air, or with a gas or mixture of inert gases, or with another foam material, so as to maximize the lagging insulating effect.

Preferably, both the mixing tank 2 and the outer coating 30, are made of wholly transparent material, so that, by using air or gas as insulating material for the air gap, the product contained in the tank 2 remains absolutely visible.

The coating 30, at the engagement hole 10, has a passage portion 31, for the dispensing group 20.

In particular, it is to be noted that the dispensing group 20 remains completely outside the coating 30 and it does not take advantage of the insulating effect of the same. However this does not invalidate the effectiveness of the machine in terms of product preservation as, as it will be clearly described hereinafter, the specific shape of the dispensing group makes superfluous the thermal insulation of the group itself.

By making reference to the subsequent figures, a dispensing group 20 according to the present invention is shown.

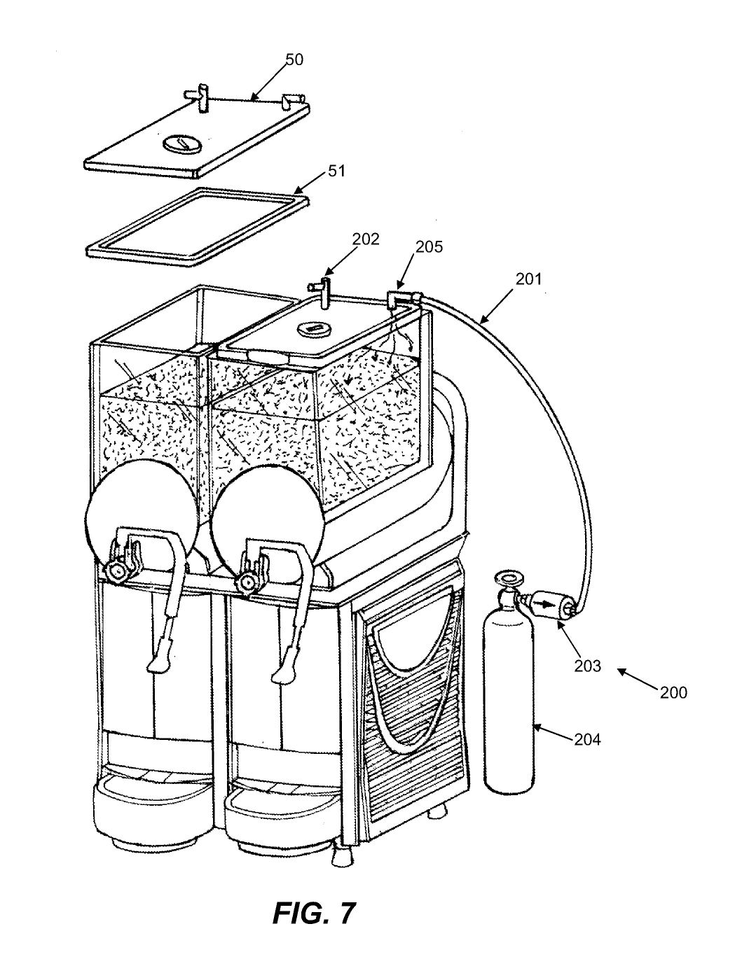

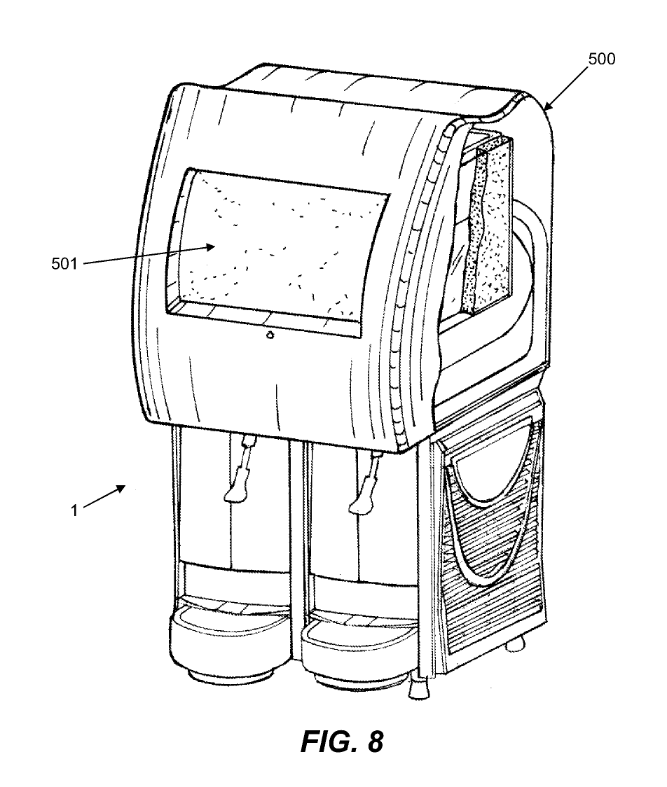

In particular, FIG. 5 shows an exploded dispensing group 20, whereas FIGS. 6A and 6B show the dispensing group in the closed and open configurations, respectively.

More in detail, the dispensing group 20 comprises a main duct 21 equipped with means for engaging in the engagement hole 10 implemented on the front wall 5 of the mixing tank 2.

As already explained, the modes therewith the engagement is performed are to be considered within the comprehension of a person skilled in the art. By way of example, the means for the engagement can be of screw, bayonet or still interlocking type.

The duct 21 further has a side opening 22 for dispensing the product.

According to the preferred embodiment, the side opening 22 is implemented as a dispensing hole implemented on a side wall of the main duct 21 and it is without a dispensing duct projecting from said side wall. As it will be explained hereinafter, this makes possible to keep the machine perfectly clean during use, by avoiding the possible stagnation of not dispensed product in the dispensing duct itself.

Inside the main duct 21 a tap element 23 is housed, sealingly sliding within the main duct 21 and equipped with a sealing element 24.

The tap element 23 for example can be moved by means of an actuation lever 25, hinged on the main duct 21.

It is still to be meant that such mode for actuating the tap is to be considered as an example and not for limiting purposes. In fact, the tap could be actuated in other ways, even by means of a powered actuator or other.

In each case, the tap element 23 should be able to assume at least a closing position, shown in FIG. 6A, wherein the sealing element 24 cooperates with an abutment surface proximate to the engagement hole 10 by preventing the product from outgoing from the tank 2, and a dispensing position, shown in FIG. 6B, wherein the sealing element 24 is spaced apart from the engagement hole 10 so as to put into communication the inner portion of the tank 2 with the dispensing side opening 22, through the engagement hole 10.

It is to be noted that when the tap is in the closed configuration, the sealing element is exactly ‘flush’ with the wall of the mixing tank 2. This then allows to have no machine portion, outside the tank 2, wherein product could stagnate and which is not suitable sealed. More in detail, it is to be noted that the whole dispensing group is so as not to have regions for accumulating not dispensed product and, for this reason, the dispensing group itself does not require any thermal insulation.

Furthermore, the sliding of the sealing element 24 between the two (closing and dispensing) configurations implements a procedure for cleaning the duct itself. In fact after a dispensing procedure and during the tap closing, the whole not dispensed product is pushed again in the mixing tank.

At last, the lack in any dispensing duct projecting from the side wall of the main duct 21 avoids definitively each accumulation of residual product after one dispensing procedure.

According to an alternative embodiment, a countertop machine like the one described sofar advantageously can comprise a system 200 for supplying a gas in the mixing tank 2, arranged to keep a substantially constant pressure level in the mixing tank 2 through an adjustment of the gas supply.

This system, which can be used for producing and thus supplying beverages or carbonated crushed-ice drinks, comprises a duct 201 for inletting gas in the mixing tank 2 and a safety valve 202 for compensating possible overpressures.

Of course, in order to make the system to operate correctly, it is preferable that the mixing tank 2 is equipped with a removable lid 50 for closing said mixing tank 2.

The seal of the lid 50 on the edge of the mixing tank 2 is implemented, for example, through a peripheral gasket element 51.

The lid 50, advantageously, can provide the assembly both of the safety valve 202 and an outlet for the gas inletting duct 201.

The gas, typically CO₂, can be supplied for example through a cylinder 204, wherein it is contained under vacuum, but of course different supplying modes can be provided.

At last, according to still an additional embodiment, a machine according to the present invention can comprise an outer element 500 covering said mixing tank 2.

Advantageously, as shown by way of example in FIG. 10, such outer covering element 500 can have a portion 505 which can be opened for inspection and/or maintenance, for example hinged at a hinge axis 503.

By way of example, according to a variant of the present invention, the outer covering element 500 can comprise a monitor 501 which can be used for displaying images and/or multimedia content.

The present invention has been sofar described according to preferred embodiments thereof, shown by way of example and not for limitative purposes.

It is to be meant that other embodiments can be provided, even obtainable as different combinations with respect to the described ones, all to be considered within the protective scope of the same, as defined by the enclosed claims.

1. A countertop machine for producing and dispensing products in a form of beverages and/or crushed-ice drinks, comprising:
a tank for mixing the product, comprising a mixing group with horizontal development, the tank having a front wall and a corresponding rear wall, side walls and a bottom;
a dispensing group with horizontal development, engaged in a corresponding engagement hole of the front wall of said tank proximate to said bottom;
an outer coating of said mixing tank implemented so as to form a hollow and sealed lagging element, defining a continuous air gap along said front, rear, side walls and said bottom of the mixing tank; and
wherein the dispensing group remains completely outside said coating and comprises:
a main duct equipped with an engagement portion in said engagement hole on the front wall of the mixing tank and a side opening for dispensing the product; and
a tap element sealingly sliding within said main duct and equipped with a sealing element, so as to be able to assume at least a closing position wherein said sealing element cooperates with an abutment surface proximate to said engagement hole by preventing the product from outgoing from the tank, and a dispensing position wherein said sealing element is spaced apart from said engagement hole so as to put in communication said tank with said side opening through said engagement hole.

2. The countertop machine according to claim 1, wherein said air gap can be filled-in with air, or a gas or a mixture of inert gases, or with a foam material.

3. The countertop machine according to claim 1, wherein said coating is formed by at least two portions coupled and sealed therebetween during an assembling phase.

4. The countertop machine according to claim 1, wherein said side opening is a dispensing hole in a side wall of said main duct and it is without a dispensing duct projecting from said side wall.

5. The countertop machine according to claim 1, comprising a gas-supplying system for supplying a gas in the mixing tank apt to keep a substantially constant pressure level in the mixing tank by adjusting the gas supply.

6. The countertop machine according to claim 5, wherein said gas-supplying system comprises a pas inletting duct for inletting the gas into the mixing tank and a safety valve for compensating possible overpressures.

7. The countertop machine according to claim 1, further comprising a removable lid for closing said mixing tank.

8. The countertop machine according to claim 7, wherein said lid implements a seal on the edge of the mixing tank.

9. The countertop machine according to claim 8, wherein said seal is a peripheral gasket element.

10. The countertop machine according to claim 6, further comprising a removable lid for closing said mixing tank, wherein said lid carries said safety valve and an outlet for said gas inletting duct.

11. The countertop machine according to claim 1, comprising an outer element for covering said mixing tank.

12. The countertop machine according to claim 6, wherein said outer covering element has a portion which can be opened for inspection and/or maintenance.

13. The countertop machine according to claim 6, wherein said outer covering element comprises a monitor which can be used for displaying images and/or multimedia content.

14. The countertop machine according to claim 1, comprising two or more mixing tanks put near therebetween.

15. The countertop machine according to claim 1, further comprising a group for cooling/heating the product included in the mixing tank.

16. The countertop machine according to claim 15, wherein the refrigerating cycle of said cooling/heating group is capable of being inverted.
